(19) United States
(12) Patent Application Publication
(10) Pub. No.: US 2005/0033664 A1
(43) Pub. Date: Feb. 10, 2005

(54) System and method for providing selective content in an electronic commerce environment

(75) Inventors: Roger Moon, Raleigh, NC (US); Yong Pak, Durham, NC (US); Scott W. Anderson, Raleigh, NC (US); Jason Williams, Raleigh, NC (US); Samuel Sutjiono, Raleigh, NC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Web Commerce Group, Raleigh, NC (US)

(21) Appl. No.: 10/882,396

(22) Filed: Jul. 2, 2004

Related U.S. Application Data
(60) Provisional application No. 60/484,280, filed on Jul. 3, 2003.

(51) Int. Cl. G06F 17/60

(52) U.S. Cl. 705/27

(57) ABSTRACT

A system and method are provided for enhancing brand power and distribution channel relationships to satisfy online customers in electronic commercial transactions. In particular, the present system creates a deep collection of products of corporate importance from across the Internet and enables visitors at the organization's web site to find and purchase those items through existing retail and other distribution channels. Additionally, the highly customizable nature of the present invention enables the system to be delivered turnkey as a managed application, implemented without significant impact on the organization's technical operations or business processes. In one embodiment, users of a brand owner's web site can search from a collection of brand-related products available through distribution channel partners, online retailers and distributors. The users may then purchase a product by linking directly to the order entry system of affiliated distribution channel partners. In this manner, the brand owner doesn't alienate them, as well as causing brand dilution in the minds of consumers, or incurring lost sales through distributor-level competition and confusion.

### CONTINUITY DATA

This application claims priority to Provisional Application 60/484,280 filed Jul. 3, 2003.

### BACKGROUND OF THE INVENTION

The present invention relates generally to systems and methods for facilitating electronic commerce. More particularly, the present invention relates to systems and methods for enhancing brand power and distribution channel relationships to satisfy online customers in electronic commercial transactions.

Most conventional electronic commerce (e-commerce) environments operate similarly to traditional brick and mortar establishments. That is, a product is developed, manufactured and marketed by a branding company and delivered to distribution markets or e-stores for sale and distribution to the end purchaser. As used herein, a brand owner or branding company shall be given a broad meaning and shall include, but is not limited to, manufacturers of products, resellers, distributors, wholesalers, original equipment manufacturers, and customizers. Further, “brand” may comprise a single brand or line or products, a family of brands or multiple brands grouped together. Because many manufacturers lack the resources required to distribute their own products or they can't afford to alienate their distribution channel partners, they are forced to rely upon such a conventional multi-level system. Unfortunately, it is a rare e-tailer who only sells products from a particular brand or manufacturer. Accordingly, the very distribution channel partners which the manufacturers rely upon to sell their products are placing those products into a competitive or confusing environment which may result in lost sales to the manufacturer. Therefore, there is a need in the art of electronic commerce for more efficient and effective methods and systems for enabling manufacturers to market and sell their merchandise from their web site, while leveraging existing distribution partners, without the risk of alienating them, causing brand dilution in the minds of consumers, or incurring lost sales through retail-level competition and confusion.

### SUMMARY OF THE INVENTION

The present invention overcomes the problems noted above and provides additional advantages through a system and method for enhancing brand power and distribution channel relationship to satisfy online customers. In particular, the present system creates a deep collection of products of corporate importance from across a network, e.g. a WAN, the Internet, and enables visitors at the organization's web site to find and purchase those products or goods through existing retail and other distribution channels. The network may be wired or wireless or a combination of such networks. Additionally, the highly customizable nature of the present invention enables the system to be delivered turnkey as a managed service, implemented without significant impact on the organization's technical operations or business processes. The invention also provides a seamless consumer experience for the visitor and streamlines the purchasing process.

In one embodiment, the present invention provides an electronic communications network-based commerce system consisting of a plurality of user interface devices, at least one brand owner server computer, and a plurality of electronic merchant computer systems, each electronic merchant computer systems operable to supply information relating to and sell products of one or more brand owners. The commerce system also comprises a data center computer system communicatively coupled to the brand owner server computers and the electronic merchant computer systems for facilitating brand specific presentation and selection for purchase of products by a user through the user's interface device from the plurality of electronic merchant computer systems.

Another embodiment of the present invention provides an electronic commerce system for use on a communications network that interconnects a plurality of user interface devices, at least one brand owner server computer, and a plurality of electronic merchant computer systems. Each of the electronic merchant computer systems is operable to supply information about and to sell products of one or more brand owners. In this embodiment, the electronic commerce system comprises a data center computer system communicatively coupled over the network to the at least one brand owner server computer and the electronic merchant computer systems for facilitating brand specific presentation and selection for purchase of products by a user through the user's interface device from the plurality of electronic merchant computer systems while the user accesses the at least one brand owner server computer with his interface device.

Yet another embodiment of the present invention provides a method for presenting and selling brand specific goods to consumers from a plurality of sources over a communications network. In this embodiment, a product database is accessed which contains electronic links to products available for purchase over the communication network from a plurality of different electronic merchants and associates items in the product database with one or more product description fields. The method according to this embodiment also comprises specifying brand owner criteria for filtering products from said product database to present to a consumer in response to the consumer query for products of a particular brand. Finally, the method according to this embodiment comprises presenting products, including electronic links to purchase said presented products from at least one of said plurality of sources, selected from said product database based on said brand owner criteria and a consumer query, to the consumer over a communication device connected to said communications network.

Yet an additional embodiment according to this invention provides a method for providing brand enhanced online shopping to patrons of a brand owners Internet website. The method according to this embodiment consists of the steps of creating a database of products offered from a plurality of e-commerce vendors over the Internet, applying a set of brand owner criteria to the products in the database, for products which meet the brand owner criteria, associating a site ID of the brand owner with those products, and in response to a user command to shop for products executed while on the Internet website of the brand owner, presenting a catalog of products which have the site ID of that brand owner and which correspond to a type of products requested by the user, including a link to purchase those products from their respective e-commerce vendor.

Still a further embodiment according to this invention provides a method for enabling a consumer for to shop for and purchase a brand owner's goods from a plurality of different electronic merchants' Internet websites through the brand owner's website. The method according to this embodiment is characterized by presenting a list of products to a consumer viewable with a browser software executed on an electronic device of the consumer while the consumer visits the brand owner's Internet website, wherein each product of said list includes a link to an electronic merchant website offering said product for sale and which satisfies one or more brand owner criteria, allowing a user to select at least one of said products from said list for purchase, and directing the consumer to the electronic merchant website associated with the selected product.

Yet another embodiment according to this invention provides a computer readable storage medium containing computer readable instructions for causing a computer to execute a program for presenting and selling brand specific goods to a consumer from a plurality of sources over a communications network while the consumer accesses a brand owner computer over the network. This embodiment includes instructions for accessing a product database containing electronic links to products available for purchase over the communication network from a plurality of different sources said product characterized in said database by one or more product description fields, instructions for specifying brand owner criteria for filtering products from said product database to present to the consumer in response to a query by the consumer for products of a particular category, and instructions for presenting products, including electronic links to purchase said presented products, from said product database based on said brand owner criteria and the consumer query to a communication device of that consumer.

One additional embodiment of this invention discloses a method for creating a product catalog comprising populating a product database containing products offered for sale by various electronic merchants over a communications network and associating products in the product database with product categories in a product catalog such that the product catalog contains products from a variety of different electronic merchants and such that the product catalog is operable to be queried to return products of a particular brand owner offered for sale by one or more of the variety of different electronic merchants. In a preferred embodiment the communications network is the Internet, the brand owner network server is a web server associated with the at least one brand owner and each at least one merchant server is a web server associated with a respective web-based merchant. According to this embodiment, the step of populating a product database comprises at least one of periodically receiving a data feed from one or more of the various electronic merchants, searching the Internet using a web crawler software to search for goods offered for sale from a variety of different online retailers, or obtaining data in real time from merchants using the web services protocol.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention can be understood more completely by reading the following Detailed Description of the invention, in conjunction with the accompanying drawings, in which:

FIG. 1 is a block diagram illustrating a distributed computer network incorporating the selective content electronic commerce system of the present invention;

FIG. 2 is a flow diagram illustrating one embodiment of a method for creating a selective content database of products for presentation to online consumers in accordance with at least one embodiment of this invention;

FIG. 3 is a flow diagram illustrating one embodiment of the invention for providing selective content in an electronic commerce environment in accordance with at least one embodiment of this invention;

FIG. 4 is a block diagram illustrating the invention as a system for establishing a customized product index in accordance with at least one embodiment of this invention; and

FIG. 5 is a block diagram illustrating one embodiment of a software-based architecture resident on a data center computer system for enabling product selection, filtering, storage and retrieval in accordance with at least one embodiment of the present invention.

### DETAILED DESCRIPTION OF THE INVENTION

The system and method of the present invention described below, may be implemented by at least one interactive computer software system incorporated within a computer-readable medium such as a hard disk drive, an optical medium such as a compact disc, or other acceptable medium. In general, the inventive computer-based system includes multiple elements which together gather and format product information and, simultaneously, make the gathered products available to consumers for subsequent viewing/purchasing through existing distribution channels.

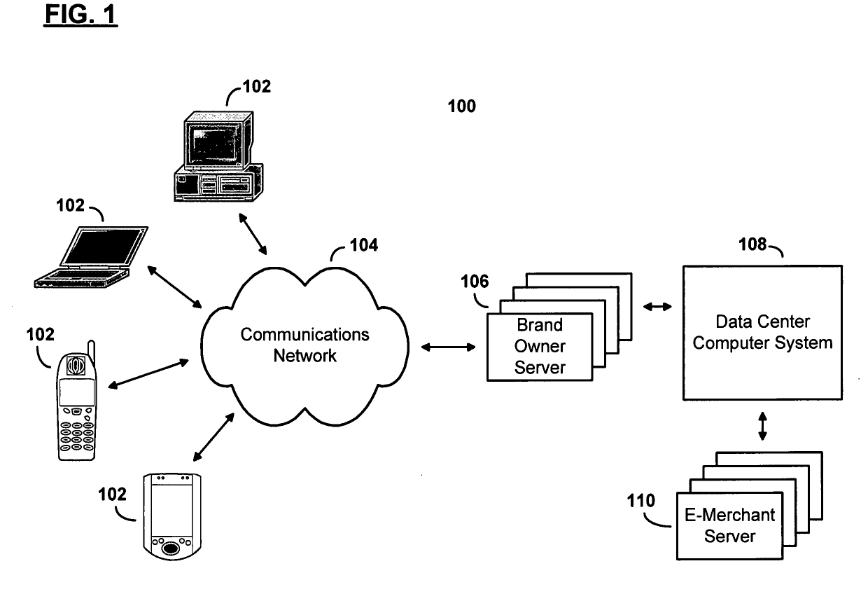

Referring now to FIG. 1, there is shown one example of a computer-based system 100 for use with one embodiment of the present invention. In particular, a plurality of conventional processor-based client computer systems 102, executing client browser applications, are connected typically through network service providers to a suitable computer network or networks 104, e.g., the Internet.

Each client computer system 102 may include, for instance, a personal computer or mobile device running the Microsoft Windows™ 95, 98, Millenium™, NT™, XP™, or 2000, Windows™ CE™, Windows Mobile™, PalmOS™, Unix, Linux, Solaris™, OS/2™, BeOS™, MacOS™ or any other suitable operating system or platform. Client system 102 may also include a microprocessor such as an Intel x86-based device, a Motorola 68K or PowerPC™ device, a MIPS, Hewlett-Packard Precision™, or Digital Equipment Corp (DEC) Alpha™ RISC processor, a microcontroller or other general or special purpose device operating under programmed control.

In accordance with the present invention, a plurality of brand owner server computer systems 106 are also coupled typically through a network service provider to the either wireless and/or wired computer network 104. Each of the server computer systems 106 may be, or include, for instance, a workstation running the Microsoft Windows™ NT™, Windows™ 2000, Windows™ XP™, Unix, Linux, Xenix, IBM AIX™, Hewlett-Packard UX™, Novell Netware™, Sun Microsystems Solaris™, OS/2™, BeOS™, Mach, Apache, OpenStep™ or other suitable operating system or platform. Further, each brand owner server computer system 106 typically executes a web server application to serve at least one, though typically many, web pages stored as files in HTML format and/or other formats. As is known in the art, each brand owner server computer system 106 may further include several individual server computers at various locations on the network.

In accordance with the present invention, a plurality of e-merchant computer systems 110 are also coupled, typically through one or more network service providers to the communications network 104. The e-merchant computer systems are similar in design to the brand owner server computer systems 106 in that they also typically execute a web server application serving one or more web pages viewable with a browser. Theses web pages usually include pictures and descriptions of products offered for sale. The products are typically categorized and may include products of a variety of different manufacturers/brand owners. The e-merchant computer server systems 110 also are typically enabled to facilitate secure online shopping transactions for the products featured on their web sites.

In addition to typical brand owner server computer systems 106, the system of the present invention also preferably includes at least one data center computer system 108 for storing and providing supporting data for relay through the server computer systems 106 to client systems 102. In a preferred embodiment, it is the data center computer system 108 that provides the underlying functionality for collecting, filtering and disseminating the desired content originating from the E-merchant server computer systems 110 to the end consumers. Additional details regarding the operation and functions performed by the data center computer system will be set forth in additional detail below.

As discussed above, in addition to the brand owner server computer system 106, and the data center computer system 108, there is also provided a plurality of retailer/distributor (E-merchant) server computer systems 110 provided for hosting the transaction-level processing related to the actual purchase. In operation, the retailer/distributor server computer systems 110 are connected to the data center computer system 108 for receiving user purchase requests initiated by user visitation to the web site hosted on the brand owner server computer systems 106.

In general operation, the client system 102 requests a display of a Web page stored on the brand owner server computer system 106 by issuing a URL request through the network 104 to the brand owner server computer system 106. A URL consistent with the present invention may be a simple URL of the form:
<protocol identifiers>://<server path>/<web page path>

A “protocol identifier” of “http” specifies the conventional hyper-text transfer protocol. A URL request for a secure Internet transaction typically utilizes the secure protocol identifier “https”, assuming that the client browser application and World Wide Web or Web server application are presumed to support and implement the secure sockets layer. The “server path” is typically of the form “prefix.domain,” where the prefix is typically “www” to designate a Web server and the “domain” is the standard Internet sub-domain.top-level-domain of the server computer system 106. The optional “web page path” is provided to specifically identify a particular hyper-text page maintained by the Web server.

In response to a received URL identifying an existing Web page, the brand owner server system 106 returns the Web page, subject to the HTTP protocol, to the client system 102 for display on the client system 102. Additionally, in accordance with the present invention, the brand owner server computer system 106 may retrieve information associated with the user request from the at least one data center computer 108. Alternatively, the server computer system 106 may also at some point, e.g., in response to a user receiver request, shift the user's connection to the data center computer system 108 or retailer/distributor server computer system 110, thereby temporarily bypassing the server computer system 106. In general, the web page(s) displayed typically incorporates both textual and graphical information including embedded hyper-text links that permit the user of client system 102 to readily select a next URL or send other data over the network 104.

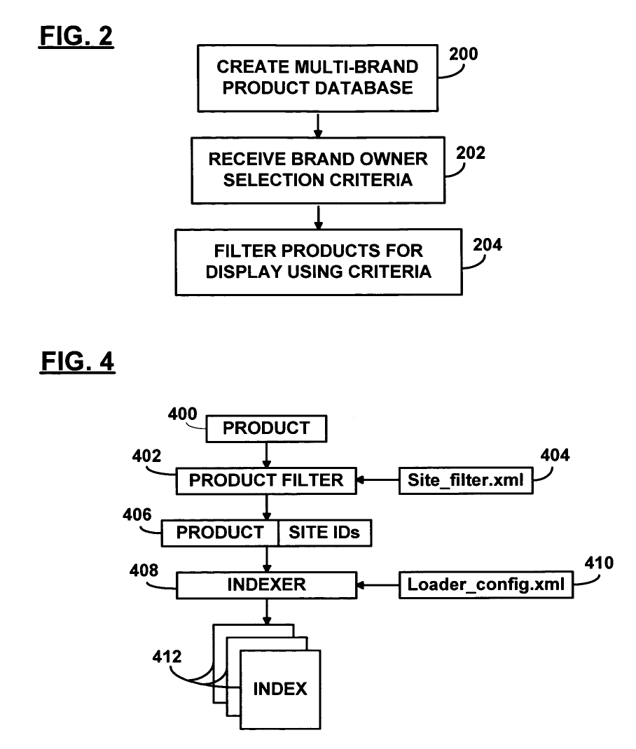

Referring now to FIG. 2, there is shown a flow diagram illustrating one embodiment of a method for collecting selective content for dissemination to purchasers. Initially, in step 200, an overall database of available products and merchants is created to service any potential brand owner. In one exemplary embodiment, the product database is created in an autonomous manner by electronic web crawler software that examines electronic retailer offerings and catalogs those offerings for subsequent retrieval in response to brand owner filtering requests. Alternatively, product information may be entered into the database manually or through any other suitable means. In another exemplary embodiments, data is entered into the database via periodic data feeds from the various electronic merchants. This embodiment is preferable to that of the web crawler because it reduces and/or eliminates the task of searching through unneeded information. In yet an additional embodiment, this information is obtained in real time directly from the various electronic merchants using the web services protocol. Additionally, product entries within the database include several discrete elements, including any categories or keywords associated with the product, the name of the product, the merchant offering the product, the price of the product, an image of the product, and a link to enable direct purchasing of the product from the associated merchant.

Once the broad catalog/database of products has been established, it is then necessary to identify the criteria by which the realm of products may be selected for particular brand owners, in order to provide for e-commerce brand enhancement. Accordingly, in step 202, product selection criteria is received from the brand owners. Such selection criteria may include any combination of product keywords, categories, merchants, etc., that together enable the identification of brand-specific products to be directed to the consumer. In step 204, the collected products, as well as any additionally added products, are filtered in view of the product selection criteria established in step 202 to create a brand-specific subset of available products and merchants. In one embodiment, a site identification associated with the brand owner is appended to the product information if the product meets the specified product selection criteria. In this manner, only products including this site identification may be returned in response to product searches originating from the brand owner's web site.

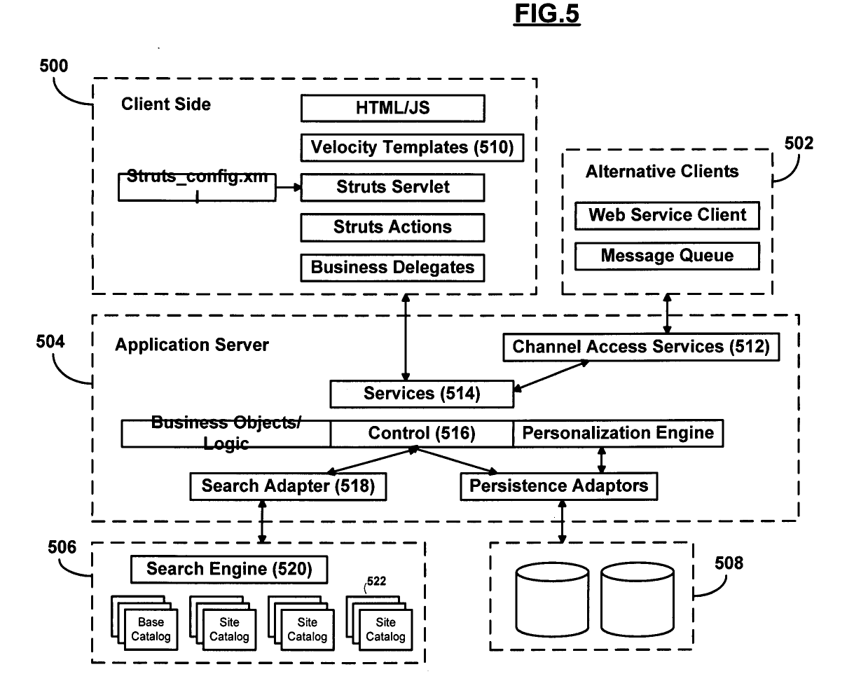

FIG. 4 is a block diagram illustrating one system for establishing a customized product index. A collection of products 400 is filtered by a filtering process 402 utilizing a site-filter document 404 containing the brand owner specified criteria. In one embodiment, such a site-filter document is created using extensible markup language (XML), however any suitable format could be utilized. One example of a site-filter XML document is attached to this application as Appendix A. Once the product index has been filtered, a collection of products and associated site identifications 406 are generated. Next, an indexer element 408 creates the end-index of available products 412 using a loader-configuration document 410. One of the key aspects of the loader-configuration document is that it specifies the rules necessary to instruct the Indexer how to map products to appropriate product categories. As discussed above, such a loader-configuration document may be created using extensible markup language (XML), however any suitable format could be utilized. One example of a site-filter XML document is attached to this application as Appendix B.

By including the site identification with the product entry in the broad product database, all brand owners may be serviced from a single collective database without the risk of non-complying products being featured and without requiring on-the-fly filtering at each product request. Once the products have been collected and filtered, they are ready for searching and selection by consumers visiting the brand owner's web site.

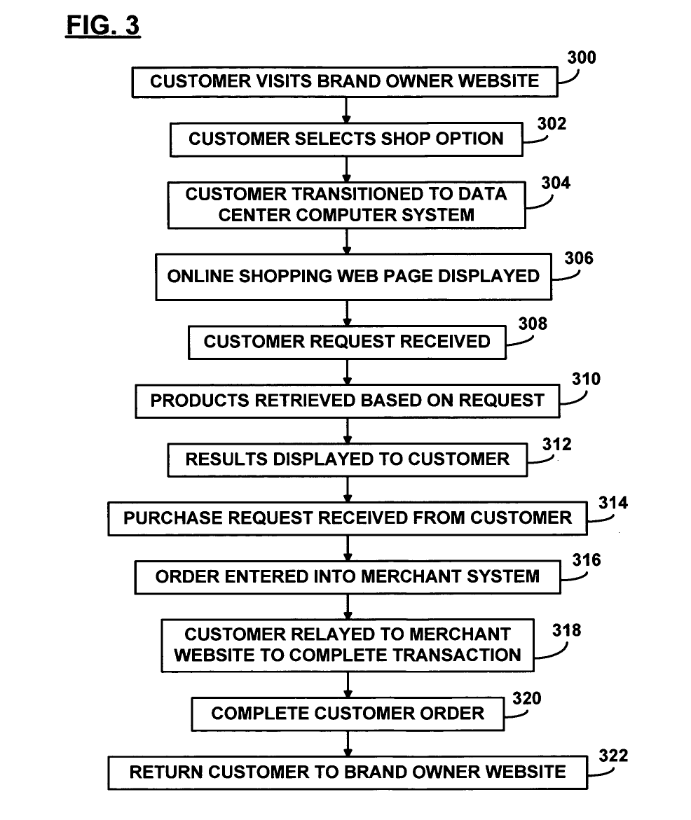

Referring now to FIG. 3, there is shown a flow diagram illustrating one embodiment of a method for providing selective content in an electronic commerce environment. Initially, in step 300, a user visits an organization's, such as a brand owner's, web site hosted on at least one server computer system associated with the organization. Next, in step 302, the user selects a “shop” or other suitable option for initiating an electronic-commerce session with the organization. Then, in various exemplary embodiments, in step 304, the user is transitioned to a data center computer system designed to facilitate the offering of brand enhanced products to the consumer. In one embodiment, the data center computer system is provided and maintained by a third party although such a scenario is not required in the present invention. Alternatively, the data center computer system may be maintained by the brand owner or an affiliate as part of its own server computer system.

Next, in step 306, an online shopping web page is displayed to the user featuring brand owner selected product offerings or merchants. In one embodiment, the brand owner selected product offerings are selected from various products maintained on the overall product database and including the site identification associated with the brand owner. Next, in step 308, the data center computer system receives a user request to search for a particular product or range of products fulfilling submitted search criteria. In response to this request, in step 310, the data center computer system, for example, utilizing search engine technology, retrieves products meeting the user's criteria and also including the site identification associated with the brand owner's web site. In step 312, the results of the retrieval are displayed to the user for product selection and/or additional search.

In step 314, a purchase request for a particular product from a particular merchant is received from the user or customer. Next, in step 316, in response to such a request, the data center computer system places an order for the desired product into the order entry system of the selected merchant. Then, in step 318, the user is relayed (at least in part) to the order completion page of the particular merchant, with the selected product ready to be placed into the merchant's “shopping cart” system for that consumer. In this manner, users are able to search for and purchase brand-specific products without wading through a myriad of competing products and brands. Following order completion in step 320, the user is returned to the brand owner's web site in step 322.

Referring now to FIG. 5, there is shown a block diagram illustrating one embodiment of a software-based architecture resident on the data center computer system 108 for enabling product selection, filtering, storage and retrieval in accordance with the present invention. In particular, the software architecture provides five generalized elements including a client-side element 500, an alternative clients element 502, an application server element 504, a search engine/catalog element 506 and a database element 508. Each of the elements operate together to provide for product filtering, database creation and search engine processes.

More particularly, the client-side element 500 includes technology for interfacing the data center computer system with the end user client systems 102. This technology includes one or more velocity templates 510 for enabling customization of layout and facilitating feature personalization. A default template can be maintained for those sites not needing a custom layout. The business delegates function as a pattern which is used to interface to various APIs. For example, if the services layer has to change interface the business delegates layer serves as an interface to the services layer for the client side 500. The Struts layer is code developed and used as a gateway to call services. Struts actions provide a framework for actions such as logging. Only a few actions generate thousands of pages of content. Therefore, the struts actions are proprietary code which plugs into the struts framework allowing the client side to call business services. The struts servlets call actions. An action will generate and fill variables to pass to the velocity template. The velocity template looks similar to HTML code that reference variables from the struts servlet. The velocity template may be specific to a particular customer depending upon the look an functionality desired by the customer.

The application server element 504 includes technology for interfacing between the client side element 500 and the search engine element 506. In particular, the application server element 504 includes a channel access services layer 512 (e.g. Web Services, Messaging) for facilitating common communication between different protocols; a services layer 514 for calling components in the control layer; a control layer 516 for exposing fine-grained business services that can be used by other services in the control and service layers 516, 514; and a search adaptor layer 518 retrieving catalogs from a web service of a vendor or some other source besides a local search engine repository.

The search engine element 506 includes a search engine layer 520 with a base catalog and one or more site catalog layers 522 each of which contain the products from a site's own inventory. These site catalogs 522 are not separate versions of the “base catalog” that have been filtered for keywords. Rather, they are special catalogs of goods specific to a particular brand owner that may also be searched in response to a consumer query. In various exemplary embodiments, the goods in these site catalogs may be goods not otherwise available from other brand-independent vendors. In contrast, the base catalog layer may serve more than one brand owner.

The database element 508 includes an ARKDOM commerce affiliate database layer 524 (not shown) which contains site personalization information for both sites and end users. The persistence adaptors provide an interface to the various databases in the database element 508. In various exemplary embodiments, the database element 508 may include one or more relational databases.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

```
APPENDIX A
<site-filters>
    <site name=“NFR” id=“265908626” />
    <site name=“Cotton Inc” id=“987179245”>
        <include>
```

<keyword>cotton</keyword>
<keyword>jean</keyword>
<keyword>denim</keyword>
<keyword>corduroy</keyword>
<keyword>towel</keyword>
<keyword>T-shirt</keyword>
<keyword>men's dress shirt</keyword>
<keyword>chinos</keyword>
<keyword>khakis</keyword>
<keyword>sweats</keyword>
<keyword>sweatshirt</keyword>
<keyword>sweatpant</keyword>
<keyword>undergarment</keyword>
<keyword>underwear</keyword>
<keyword>lingerie</keyword>
<keyword>panties</keyword>

```
        </include>
        <exclude>
```

<category>3</category>
<category>57</category>
<keyword>Peter Cottontail</keyword>
<keyword>cotton candy</keyword>
<keyword>Soft-as-cotton</keyword>
<keyword>cottonball jar</keyword>
<keyword>cotton ball jar</keyword>
<keyword>not cotton</keyword>
<keyword>cotton like</keyword>
<keyword>cotton-like</keyword>
<keyword>cottony</keyword>
<keyword>than cotton</keyword>
<keyword>comfort of cotton</keyword>
<keyword>feel of cotton</keyword>
<keyword>Poly/cotton</keyword>
<keyword>polyester/cotton</keyword>
<keyword>cotton jar</keyword>
<keyword>towel bar</keyword>
<keyword>towel rack</keyword>
<keyword>Rayure sleeveless</keyword>
<keyword>softness of cotton</keyword>
<keyword>Linen/cotton jacket</keyword>

```
        </exclude>
    </site>
</site-filters>
```

```
APPENDIX B
<loader-config>
    <catalogs>
        <!--
            Note that the names here need to match those
in the <category-mapping>,
            otherwise products will be dropped.
        -->
        <performics id=“23”
            name=“Kohls Department Stores”
            path=“src/examples/catalogs/kohls.txt” />
        <performics id=“24”
            name=“Linens 'n Things”
    path=“src/examples/catalogs/linensnthings.txt” />
        <performics id=“7”
            name=“Classic Closeouts”
    path=“src/examples/catalogs/classiccloseouts.txt” />
        <performics id=“31”
            name=“Pacific Sunwear”
    path=“src/examples/catalogs/pacificsunwear.txt” />
        <hanes id=“29”
            name=“One Hanes Place”
            path=“src/examples/catalogs/ohpprod.txt” />
        <performics id=“22”
            name=“Jos A Bank”
            path=“src/examples/catalogs/josabank.txt” />
        <performics id=“13”
            name=“ExOfficio”
            path=“src/examples/catalogs/exofficio.txt” />
    </catalogs>
    <!--
        Product Modifications
    -->
    <modifiers>
        <required fields=“name, url, imageUrl, sku” />
        <duplicates history=“10” fields=“name, url,
imageUrl, retailPrice” />
    <standard />
    <!--
======================================================
            CATEGORY MAPPING
=================================================== -->
        <!-- Option 1, Jeops, with a separate rule base
per store: -->
        <modifier-splitter field=“storeId”>
            <jeops base=“Category” />
        </modifier-splitter>
        <required fields=“categoryIdsAsString” />
        <!-- Option 2, Drools, with a separate rule base
per store:
        <modifier-splitter prefix=“src/examples/config/”
field=“storeId”>
            <drools file=“category-mapping.drl” />
        </modifier- splitter>
        <required fields=“categoryIdsAsString” />
        -->
        <!-- Option 3, Old Style:
        <category-mapping
file=“src/examples/config/category-mapping.xml” />
        -->
        <!--
======================================================
==
            SITE-BASED PRODUCT FILTERING
======================================================
== -->
        <site-filters file=“src/examples/config/site-
filters.xml” />
    </modifiers>
    <!--
        Sinks, for Indexing and related tasks
    -->
    <sinks>
        <splitter name=“stores” field=“storeId”
optimize=“true”>
            <index name=“products” />
            <field-serializer name=“categories”
            field=“categoryIdsAsString” />
            <field-serializer name=“prices”
field=“priceAsString” />
            <tag field=“storeName” />
        </splitter>
        <store-list prefix=“stores/” name=“list.xml” />
    </sinks>
</loader-config>
```

1. An electronic communications network based commerce system comprising:
a communications network comprising a plurality of user interface devices, at least one brand owner server computer, and a plurality of electronic merchant computer systems, each electronic merchant computer systems operable to supply information relating to and to sell products of one or more brand owners;
a data center computer system communicatively coupled to the brand owner server computers and the electronic merchant computer systems for facilitating brand specific presentation and selection for purchase of products by a user through the user's interface device from the plurality of electronic merchant computer systems.

2. The system according to claim 1, wherein the user interface devices are chosen from the group consisting of personal computers, laptop computers, hand held computers, personal digital assistants (PDAs), mobile telephones and wireless communication devices.

3. The system according to claim 1, wherein the communications network is the Internet.

4. The system according to claim 3, wherein each electronic merchant computer system comprises a commerce enabled website storing hypertext descriptions of products.

5. The system according to claim 1, wherein the data center computer system comprises a multi-brand product database and a set of brand owner criteria.

6. The system according to claim 5, wherein the multi-brand product database comprises one or more product description fields stored in association with an HTTP web address of the electronic merchant computer offering the product for sale.

7. The system according to claim 6, wherein the data center computer system comprises, for products which meet the brand owner criteria, a list of products from the product database associated with a site ID of the corresponding brand owner computer system for display to a consumer.

8. In a communications network including a plurality of user interface devices, at least one brand owner server computer, and a plurality of electronic merchant computer systems, wherein at least some of the electronic merchant computer systems are operable to supply information about and to sell products of one or more brand owners, a data center comprising:
a computer system in electronic communication with at least one brand owner server computer and a plurality of electronic merchant computer systems and adapted to receive data therefrom;
memory for storing the data and being accessible by the computer system; and
at least one module executable by the computer system and adapted to facilitate selection for purchase of one or more products by a user through the user's interface device from the plurality of electronic merchant computer systems while the user accesses the at least one brand owner server computer with his interface device.

9. The system according to claim 8, wherein the user interface devices are chosen from the group consisting of personal computers, laptop computers, hand held computers, personal digital assistants (PDAs), mobile telephones and wireless communication devices.

10. The system according to claim 8, wherein the communications network is the Internet.

11. The system according to claim 10, wherein each electronic merchant computer system comprises a commerce enabled website storing hypertext descriptions of products.

12. The system according to claim 10, wherein the data center computer system comprises a multi-brand product database and a set of brand owner criteria, wherein products meeting the brand owner's criteria are stored in association with a site I) of the brand owner.

13. The system according to claim 10, wherein the multi-brand product database comprises one or more product description fields stored in association with an HTTP web address of the electronic merchant computer offering the product for sale.

14. A method for presenting and selling brand specific goods to consumers from a plurality of sources over a communications network comprising:
accessing a product database containing electronic links to products available for purchase over the communications network from said plurality of different sources and associating items in the product database with one or more product description fields;
based at least in part on brand owner criteria, filtering products from said product database to present to a consumer in response to a consumer query for products of a particular brand; and
presenting products, including electronic links to purchase said presented products from at least one of said plurality of sources, selected from said product database based on said brand owner criteria and said consumer query, to the consumer over a communication device connected to said communications network.

15. The method according to claim 14, wherein the communications network is the Internet.

16. The method according to claim 14, wherein the step of accessing a product database comprises accessing a product database generated by proprietary filtering methods and tools for data acquired from merchants via batch file, Web services protocol, and web crawler software program and cataloging a list of available products including one or more product description fields.

17. The method according to claim 16, wherein said product description fields include categories or keywords associated with the product, the name of the product, the brand of the product, the merchant offering the product, the price of the product, an image of the product and a link to a network address enabling purchase of the product from the associated merchant.

18. The method according to claim 17, the step of specifying brand owner criteria comprising specifying, for each brand owner, which products may be selected from the product database for display to the consumer based on the value of one or more product description fields, and for products which meet the brand owner criteria, associating those products with a site ID of the brand owner.

19. The method according to claim 18, the step of presenting products to the consumer comprising displaying a list of brand specific products including a description and/or image of said products on a display screen of the consumer's communication device, including, for each a product, a link to purchase the product from the electronic merchant associated with that product, based on a request by the consumer while the consumer visits an Internet website associated with the brand owner.

20. The method according to claim 15, further comprising, after the consumer has selected a product, directing the consumer to the merchant's website to finalize the transaction of that selected product.

21. The method according to claim 20, directing the consumer to the merchant's website further comprising directing the consumer such that when the consumer arrives at the merchant's website, the selected product is ready to be placed into a shopping cart by the consumer for purchase.

22. The method according to claim 20, after the consumer has finalized the transaction, further comprising returning the consumer to the brand owner's website.

23. A method for providing brand enhanced online shopping to patrons of a brand owner's Internet website comprising:
creating a database of products offered from a plurality of e-commerce vendors over the Internet;
applying a set of brand owner criteria to the products in the database;
for products which meet the brand owner criteria, associating a brand owner site ID with those products; and
in response to a user command to shop for products executed while on the brand owner's Internet website, presenting a catalog of products which have the site ID of that brand owner and which correspond to a type of products requested by the user, including a link to purchase those products from their respective e-commerce vendor.

24. The method according to claim 23, the step of creating a product database comprising applying proprietary filtering methods and tools against data acquired from merchants via batch file, Web services protocol, and web crawler software program and generating a list of products associated with one or more product description fields and the web address of the e-commerce website offering that product for sale.

25. The method according to claim 24, wherein said product description fields include categories or keywords associated with the product, the name of the product, the brand of the product, the merchant offering the product, the price of the product, an image of the product and a link to a network address enabling purchase of the product from the associated merchant

26. The method according to claim 25, the step of applying a set of brand owner criteria comprising, associating products in the product database with the site ID of the brand owner based on the value of one or more of the product description fields.

27. The method according to claim 23, further comprising, in response to a user command to purchase a product, transferring the user to the website of the e-commerce vendor associated with that product in the product database.

28. A method for enabling a consumer to shop for and purchase a brand owner's products from a plurality of different electronic merchants' Internet websites through the brand owner's website comprising:
at the brand owner's website, receiving a consumer query associated with at least one brand owner product;
presenting, in response to the query, a list representing at least one product associated with the brand owner, said at least one product available for purchase from at least one electronic merchant, the list viewable with a browser software executed on an electronic device of the consumer, wherein the list includes a link to a website of the at least one electronic merchant offering said product for sale;
allowing a user to select at least one link from said list; and
directing the consumer to the electronic merchant website associated with the selected product.

29. The method according to claim 28, wherein the presenting step is based at least in part on brand owner specified criteria.

30. The method according to claim 28, the step of directing the consumer to the electronic merchant website associated with the selected product comprising directing the consumer such that the selected product is ready to be placed into a shopping cart by the consumer for purchase.

31. The method according to claim 30, further comprising, after the consumer has purchased the product, returning the user to the website of the brand owner.

32. A computer readable storage medium containing computer readable instructions for causing a computer to execute a program for presenting and selling brand specific goods to a consumer from a plurality of sources over a communications network while the consumer accesses a brand owner computer over the network, comprising:
instructions for accessing a product database containing electronic links to products available for purchase over the communication network from a plurality of different sources said product characterized in said database by one or more product description fields;
instructions for specifying brand owner criteria for filtering products from said product database to present to the consumer in response to a query by the consumer for products of a particular category; and
instructions for presenting products, including electronic links to purchase said presented products, from said product database based on said brand owner criteria and the consumer query to a communication device of that consumer.

33. The computer readable storage medium according to claim 32, said instructions for accessing a product database comprising instructions for accessing a product database containing one or more product description fields in association with the address of the network location offering the product for sale.

34. The computer readable storage medium according to claim 33, said instructions for specifying brand owner criteria including instructions for associating a site ID of the brand owner with products in the product database which satisfy that brand owner's criteria based on the value of at least one product description field.

35. The computer readable storage medium according to claim 32, said instructions for presenting products, including instructions for displaying on a browser client executing on the consumer's communications device, in response to a shop command executed by a user, pictures and descriptions of products which satisfy the brand owner's criteria and the consumer's query, said pictures and descriptions including a link to purchase the products from their respective sources, said plurality of different sources comprising a plurality of different network-based electronic merchants.

36. The computer readable storage medium according to claim 34, further comprising instructions for permitting a purchase of a product from one of the plurality of network-based electronic merchants including instructions for directing the consumer to a website associated with that electronic merchant such that a selected product is ready to be placed into a shopping cart by the consumer for purchase.

37. In a network environment consisting of at least one brand owner having a brand owner network server associated therewith, and a plurality of electronic merchants each merchant having at least one merchant network server associated therewith, each merchant offering for sale goods of one or more brand owners through their respective at least one merchant server, a method for creating a product catalog comprising:
populating a product database containing products offered for sale by various electronic merchants over a communications network;
associating products in the product database with product categories in a product catalog such that the product catalog contains products from a variety of different electronic merchants and such that the product catalog is operable to be queried to return products of a particular brand owner offered for sale by one or more of the variety of different electronic merchants;
creating a virtual retail network from independent electronic merchants who carry products from various brand owners, seemingly dedicated to selling a specific brand owner's products only while keeping consumers away from competitive brands; and
creating an authentic product catalog of a brand owner from which consumers can purchase one or more products through electronic merchants authorized by the brand owner.

38. The method according to claim 37, wherein the communications network is the Internet, the brand owner network server is a web server associated with the at least one brand owner and each at least one merchant server is a web server associated with a respective web-based merchant.

39. The method according to claim 38, wherein the step of populating a product database comprises periodically receiving a data feed from one or more of the various electronic merchants.

40. The method according to claim 38, wherein the step of populating a product database comprises searching the Internet using a web crawler software to search for goods offered for sale from a variety of different online retailers.

41. The method according to claim 38, where in the step of populating a product database comprises obtaining data in real time from merchants using the web services protocol.
